(19) United States
(12) Patent Application Publication
(10) Pub. No.: US 2025/0291865 A1
(43) Pub. Date: Sep. 18, 2025

(54) METHOD OF PROVIDING INDOOR MAP SEARCH SERVICE AND DEVICE FOR IMPLEMENTING THE SAME

(71) Applicant: KAKAO CORP., Jeju-si (KR)

(72) Inventors: Youngjin CHOI, Seongnam-si (KR); Ahrum KANG, Seongnam-si (KR); Hyoju CHOI, Seongnam-si (KR); Sung Bum PARK, Seongnam-si (KR); Hyunhee JOE, Seongnam-si (KR); Binnara LEE, Seongnam-si (KR); Jaiwuk CHUNG, Seongnam-si (KR); Keunhui PARK, Seongnam-si (KR); Deok Gon LEE, Seongnam-si (KR); Dongyoung YOON, Seongnam-si (KR); Gyeong-Hyeon MOON, Seongnam-si (KR); Daehyun IM, Seongnam-si (KR); Hyungchul SHIN, Seongnam-si (KR)

(73) Assignee: KAKAO CORP., Jeju-si (KR)

(21) Appl. No.: 19/076,898

(22) Filed: Mar. 11, 2025

(30) Foreign Application Priority Data
Mar. 13, 2024 (KR) 10-2024-0035465

(51) Int. Cl. G06F 16/9537; G06F 3/0485; G06F 9/451; G06F 16/9538

(52) U.S. Cl. CPC G06F 16/9537; G06F 9/451; G06F 16/9538; G06F 3/0485

(57) ABSTRACT

A method of providing an indoor map search service, according to one embodiment of the present disclosure, may include: rendering and displaying, on a map screen, a background map and an indoor map of a point of interest (POI) on the background map; and displaying, in an area of the map screen, a facility information search user interface (UI) that facilitates a search for facility information about facilities included in the indoor map.

### CROSS-REFERENCE TO RELATED APPLICATIONS

This application claims the benefit under 35 USC § 119(a) of Korean Patent Application No. 10-2024-0035465 filed on Mar. 13, 2024, in the Korean Intellectual Property Office, the entire disclosure of which is incorporated herein by reference for all purposes.

### BACKGROUND

### Technical Field

The present disclosure relates to a method of providing an indoor map search service and a device for implementing the method and, more particularly, to a method of providing an indoor map search service and a device for implementing the method to display preferentially search results for places or facilities included in an indoor map while facilitating a simple and intuitive search for facility information about facilities included in the indoor map.

### Description of Related Art

In recent years, there has been a lifestyle change in which a growing number of people are visiting large shopping malls, amid the emergence of the term “mall sphere,” a living space that encompasses restaurants, coffee shops, and other places where people can enjoy shopping and cultural life. A large shopping mall in such a mall sphere is spacious and consists of a building or construction with multiple floors. The complex structure of such a building makes customers visiting a large shopping mall demand an easy way to check an indoor map of the shopping mall.

Accordingly, there are attempts to display an indoor map for a specific building or construction while using a typical map (hereinafter referred to as a “background map” for ease of description) of a map application.

The indoor map includes various types of facilities including public facilities such as restrooms, elevators, stairs, escalators, medical facilities, and the like, and convenient facilities (or amenities) such as information desks, stroller rentals, and the like. However, users may not easily identify a desired specific facility among these facilities on the indoor map.

Therefore, there is a need to simplify a search for various facility information when providing an indoor map to enhance user experience.

### BRIEF SUMMARY

An aspect of the present disclosure is to provide a simple and intuitive method of searching for various facility information including convenient facilities (or amenities) and public facilities on an indoor map.

Another aspect of the present disclosure is to provide a method of displaying preferentially a search result for a place (or point) or facility included in an indoor map when a user performs a search.

However, technical aspects are not limited to the preceding, and there may be other technical aspects that can be clearly understood by one of ordinary skill in the art from the following description.

Hereinafter, embodiments to achieve the aspects of the present disclosure are described.

According to one embodiment of the present disclosure, there is provided a method of providing an indoor map search service, the method including: displaying, on a map screen, a background map and an indoor map of a point of interest (POI) on the background map; and displaying, in an area of the map screen, a facility information search user interface (UI) that facilitates a search for facility information about facilities included in the indoor map.

The method may further include, in response to receiving a user selection of the facility information search UI, displaying a facility type selection UI from which one or more facility types are selectable.

The displaying of the facility type selection UI may include at least one of: displaying the facility type selection UI as an extension of the facility information search UI; displaying the facility information search UI in replacement of a UI previously displayed on the map screen; or displaying the facility information search UI in an area of the map screen.

In response to receiving an additional user selection of the facility information search UI while the facility type selection UI is being displayed, the facility type selection UI may be removed.

The facility type selection UI may be displayed as scrollable.

The one or more facility types displayed on the facility type selection UI may include at least one of a restroom, an elevator, an escalator, stairs, a medical facility, an information desk, or a stroller rental place.

The method may further include, in response to a user selection of one of the facility types displayed on the facility type selection UI, displaying an identifier at each of locations of one or more facilities within the indoor map corresponding to the selected facility type.

When there is a plurality of facilities within the indoor map corresponding to the selected facility type, any one of a plurality of identifiers respectively corresponding to the plurality of facilities may be displayed distinctively from remaining identifiers.

The one of the identifiers displayed distinctively from the remaining identifiers may correspond to a facility closest to a current location of a user.

The method may further include displaying, in an area of the map screen, detailed information about a facility corresponding to the one of the identifiers.

The map screen may include a floor level display UI for displaying floor information of the indoor map, and the facility information search UI may be displayed near the floor level display UI.

The map screen may include a search bar, and a plurality of category selection buttons below the search bar. The plurality of category selection buttons may include the facility information search UI.

In response to a selection of the facility information search UI, a portion of the plurality of category selection buttons may be changed to a facility type button and the facility type button may be displayed.

According to one embodiment of the present disclosure, there is provided a device for providing an indoor map search service, the device configured to: display, on a map screen, a background map and an indoor map of a POI on the background map; and display, in an area of the map screen, a facility information search UI that facilitates a search for facility information about facilities included in the indoor map.

According to one embodiment of the present disclosure, there is provided a non-transitory computer-readable recording medium including computer-executable instructions, wherein the computer-executable instructions may be configured to perform, when executed by a processor, a method of providing an indoor map search service. The method may include: displaying, on a map screen, a background map and an indoor map of a POI on the background map; and displaying, in an area of the map screen, a facility information search UI that facilitates a search for facility information about facilities included in the indoor map.

According to one embodiment of the present disclosure, there is provided a method of searching for a point on an indoor map, the method including: transmitting a search request; in response to an indoor map being displayed on a map screen displayed on a user terminal, transmitting identification information about the indoor map; and receiving search results corresponding to the search request, the search results including first search results for one or more points on the indoor map.

The method may further include displaying the search results on a screen of the user terminal, and the first search results may be displayed distinctively from remaining search results.

The displaying of the first search results distinctively from the remaining search results may include displaying a predetermined number of results among the first search results above the remaining search results.

The displaying of the first search results distinctively from the remaining search results may include displaying the first search results fully on the screen of the user terminal.

According to embodiments of the present disclosure, the method of providing an indoor map search service may facilitate searching for various facility information about convenient facilities (or amenities) and public facilities within an indoor map.

According to embodiments of the present disclosure, the method of providing an indoor map search service may enhance user experience by preferentially displaying search results for places (or points) or facilities included in an indoor map when a user performs a search.

However, the effects of the present disclosure are not limited to the effects described above, and other effects not described above will be apparent to one of ordinary skill in the art from the following description.

### BRIEF DESCRIPTION OF THE SEVERAL VIEWS OF THE DRAWINGS

The above and/or other aspects, features, and advantages of certain embodiments of the present disclosure may be more apparent from the following description taken in conjunction with the accompanying drawings, in which:

FIG. 1 is a diagram schematically illustrating a system for providing an indoor map search service according to one embodiment of the present disclosure;

FIG. 2 is a flowchart schematically illustrating a method of providing an indoor map search service according to one embodiment of the present disclosure;

FIGS. 3 through 9 are diagrams illustrating examples of a map screen through which an indoor map search service is provided according to one embodiment of the present disclosure;

FIG. 10 is a flowchart schematically illustrating a method of searching for facility information about facilities on an indoor map according to one embodiment of the present disclosure; and

FIGS. 11 and 12 are diagrams illustrating examples of displaying search results in a map application according to one embodiment of the present disclosure.

### DETAILED DESCRIPTION

Various embodiments of the present disclosure are described herein for the purpose of clarifying the technical ideas of the disclosure and are not intended to limit the disclosure to any particular embodiment. The technical ideas of the disclosure include various modifications, equivalents, alternatives, and optional combinations of all or parts of each of the embodiments described herein. Further, the scope of the technical ideas of the disclosure is not limited to the various embodiments set forth below or the specific descriptions thereof.

Terms used herein, including technical or scientific terms, unless otherwise defined, are intended to have the meanings commonly understood by one of ordinary skill in the art to which the disclosure pertains.

As used herein, expressions such as “includes,” “may include,” “comprises,” “may comprise,” “have/has,” “may have,” and the like, imply the presence of the subject features (e.g., functions, operations, or components, etc.) and do not exclude the presence of other additional features, i.e., these expressions are to be understood as open-ended terms that imply the possibility of including a second embodiment.

As used herein, expressions of a singular form include expressions of a plural form, unless indicated otherwise. Also, expressions of the plural form include expressions of the singular form, unless indicated otherwise. Throughout the specification, when any unit or part is described as including any component, it is meant to be inclusive of other components, not exclusive of other components, unless indicated otherwise.

In addition, as used herein, the term “module” or “unit” refers to a software or hardware component, and a “module” or “unit” may perform some function. However, the “module” or “unit” is not limited to software or hardware. The “module” or “unit” may be configured to reside on an addressable storage medium or may be configured to reproduce one or more processors. Thus, in one example, the “module” or “unit” may include at least one of components (e.g., software components, object-oriented software components, class components, and task components), processes, functions, attributes, procedures, subroutines, segments of program code, drivers, firmware, microcode, circuits, data, databases (DBs), data structures, tables, arrays, or variables. The functionality provided within the components and “modules” or “units” may be combined into fewer components and “modules” or “units” or may be further separated into additional components and additional “modules” or “units.”

According to one embodiment of the present disclosure, the “module” or “unit” may be implemented as a processor and memory. The term “processor” should be broadly interpreted as including a general-purpose processor, a central processing unit (CPU), a microprocessor, a digital signal processor (DSP), a controller, a microcontroller, a state machine, and the like. In some environments, the “processor” may also refer to an application-specific integrated circuit (ASIC), a programmable logic device (PLD), a field-programmable gate array (FPGA), and the like. The “processor” may also refer to a combination of processing devices, such as, for example, a combination of a DSP and a microprocessor, a combination of a plurality of microprocessors, a combination of one or more microprocessors coupled with a DSP core, or a combination of any other configurations. In addition, the term “memory” should be interpreted broadly as including any electronic component capable of storing electronic information. The “memory” may also refer to various types of processor-readable media, such as, for example, random-access memory (RAM), read-only memory (ROM), non-volatile random-access memory (NVRAM), programmable read-only memory (PROM), erasable programmable read-only memory (EPROM), electrically erasable programmable read-only memory (EEPROM), flash memory, magnetic or optical data storage, register, and the like. The memory is referred to as being in an electronically communicative state with the processor if the processor can read information from the memory and/or write information on the memory. The memory integrated into the processor is in an electronically communicative state with the processor.

Although the terms “first” and “second” or “initially” and “subsequently” and the like are used to distinguish one subject matter from another in referring to a plurality of homologous subjects, unless indicated otherwise, and are not intended to limit the sequence or importance of such subjects.

As used herein, the term “and/or” includes any one and any combination of any two or more of the associated listed items. The phrases “at least one of A, B, and C”, “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

As used herein, the expressions “based on” or “in response to” is used to describe one or more elements or factors affecting a decision, determination, or behavior that are described in the phrase or sentence containing such an expression, and is not intended to exclude additional elements or factors affecting such decision, determination, or behavior.

As used herein, the expression that a component (e.g., a first component) is “connected” or “coupled” to another component (e.g., a second component) may mean that the component is directly connected or coupled to the other component, as well as connected or coupled to the other component with another component (e.g., a third component) therebetween.

As used herein, the expression “configured to” may mean, depending on the context, “set to,” “having the ability to,” “altered to,” “adapted to,” “capable of,” and the like. This expression is not limited to the meaning of “specifically designed for hardware” and, for example, a processor configured to perform a specific operation may mean a generic-purpose processor capable of performing the specific operation by executing software.

Hereinafter, various embodiments of the present disclosure will be described with reference to the accompanying drawings. In the accompanying drawings and the description of the drawings, identical or substantially equivalent components may be assigned the same reference numerals. Also, in the following description of the various embodiments, duplicate descriptions of identical or corresponding components may be omitted, but this does not mean that such components are not included in the embodiments.

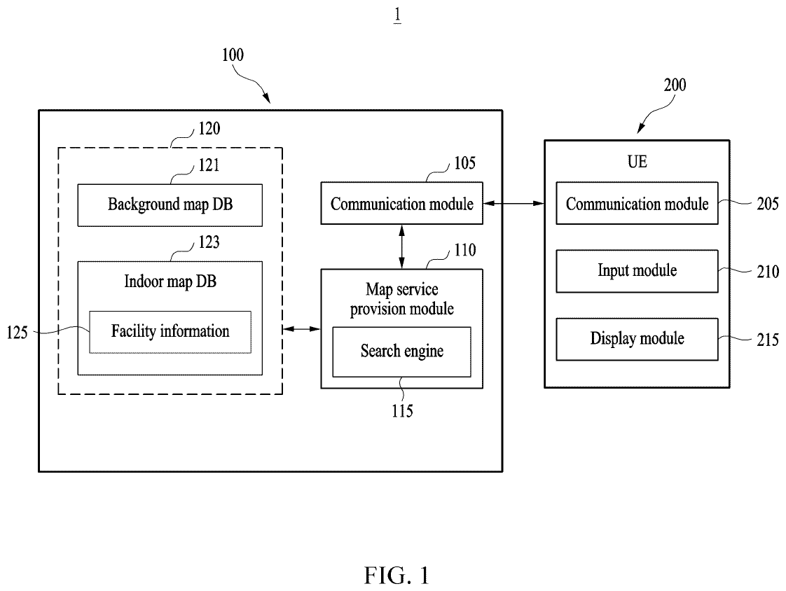

FIG. 1 is a diagram schematically illustrating a system for providing an indoor map search service according to one embodiment of the present disclosure.

Referring to FIG. 1, according to one embodiment of the present disclosure, a system 1 for providing an indoor map search service may include a server 100 for providing map information and a user terminal (e.g., user equipment (UE)) 200, which is a device for displaying the map information on a user interface (UI) of a map application based on the map information provided by the server 100. In response to a search request being received from a user via the user terminal 200, the search request may be transferred to the server 100, and the server 100 may acquire search results corresponding to the search request from a map database (DB) 120 and provide the search results to the user terminal 200.

In one embodiment, the server 100 may include a communication module 105 configured to transmit and receive various data including map information and search requests to and from the user terminal 200, a map service provision module 110 configured to acquire map information from the map DB 120 and provide the map information to the user terminal 200, a search engine 115 configured to search the map DB 120 in response to a search request received from the user terminal 200 and acquire search results, and the map DB 120 storing map information. The server 100 may be a general-purpose server that provides various services in addition to a map service including the indoor map search service, but providing the map service is primarily described herein for ease of description.

In one embodiment, the map DB 120 may include a background map DB 121 storing background map information and an indoor map DB 123 storing indoor map information. Thus, map information described herein according to embodiments of the present disclosure may be of a concept that encompasses the background map information and the indoor map information including facility information.

The background map information may include a background map displayed on a UI of a map application executed on the user terminal 200, and the background map may include a plurality of first points of interest (POIs). The background map may be representations of buildings, roads, facilities, and the like using lines or shapes (e.g., polygons). Alternatively, depending on user settings, the background map may be three-dimensional (3D) representations of buildings, roads, facilities, and the like, or a satellite image. However, examples thereof are not limited thereto. The plurality of first POIs may be predetermined places (or points) or may include affiliated places (or points) under various agreements or promotions. The first POIs may include detailed information about the first POIs, in addition to location (coordinate) information of the POIs on the background map. Accordingly, when the user selects an indicator (e.g., a marker) associated with one of the first POIs via a map screen of the user terminal 200, detailed information about the selected first POI may be provided in the form of a place panel, for example.

The indoor map information may include an indoor map provided and displayed for at least some of the plurality of first POIs displayed on the background map, and a plurality of second POIs for a first POI for which the indoor map is displayed. In this case, the indoor map may not be provided for all of the first POIs, but for some first POIs for which the indoor map is available due to some reasons, such as, because they are of a certain size or greater or they are affiliated with the server 100 (or an entity that manages the server 100) and the like. For example, a first POI for which an indoor map is provided may include, but is not limited to, a building or construction including a shopping mall, a grocery store, an airport, an underground shopping center, or the like that has a single floor or multiple floors. In a case where the first POI is a complex shopping mall, the indoor map of the first POI may include, as a plurality of second POIs, various stores, restaurants, convenient facilities (or amenities), and the like in the complex shopping mall. As such, the first POI may be a larger building or construction in which a plurality of second POIs is located, or in some cases, a first POI and a second POI may indicate the same place (or point). The first POI and the second POI may each be indicated using an indicator (e.g., a marker) or icon at a corresponding location on a map.

In one embodiment, the indoor map DB 123 may include facility information 125. The facility information 125 may include information about, among places (or points) on the indoor map, public facilities such as restrooms, elevators, stairs, escalators, medical facilities, and the like, and convenient facilities (or amenities) such as information desks, stroller rentals, and the like, but examples of the facility information 125 are not limited to specific examples. The facility information 125 may be stored separately by floor for each indoor map (i.e., each POI having an indoor map).

Although the map DB 120 is shown in FIG. 1 as being included in the server 100, there may be a separate external server that includes at least one of the background map DB 121 or the indoor map DB 123, and at least some of the map DBs may be maintained by the external server and provided to the server 100.

In one embodiment, in response to a request from the user terminal 200, the map service provision module 110 may acquire, from the map DB 120, map information to be provided to the user terminal 200. For example, in response to the user manipulating (e.g., panning, zooming in, zooming out, searching for a place (or point), etc.) a UI of a map application executed on the user terminal 200, the map service provision module 110 may receive, via the communication module 105, a request generated and transmitted by the user terminal 200, and the map service provision module 110 may provide, via the communication module 105, map information corresponding to a map screen to be displayed on the UI of the map application in response to the request from the user terminal 200.

In one embodiment, the map service provision module 110 may include the search engine 115. In response to a search request received from the user terminal 200, the search engine 115 may search the map DB 120 and generate search results. However, the search engine 115 may be implemented as a separate module from the map service provision module 110 but is not limited thereto.

In one embodiment, in a case where the search request from the user terminal 200 received by the search engine 115 is a user selection of a facility information search UI on the map screen, the search results may include coordinate information and detailed information about one or more facilities on an indoor map of a corresponding floor. As described in more detail below, the facility information search UI may be a button that facilitates searching for facility information about facilities on an indoor map displayed on the map screen.

In another embodiment, in a case where the search request from the user terminal 200 received by the search engine 115 is a search word input from the user via a search bar displayed on the map screen, the search results may include a list of places (or points) corresponding to the search word. However, in this case, when the indoor map is displayed on the map screen of the user terminal 200, the list of places (or points) may include a first list of places (or points) on the indoor map. In this case, of the search results, the first list of places (or points) on the indoor map may have a higher priority than another list of places (or points).

Although not shown, the server 100 may include a processor and a memory, and the memory may store computer-readable instructions for implementing various functions of the server 100. The processor may execute these computer-readable instructions to implement various modules including the map service provision module 110, the search engine 115, and other modules shown in FIG. 1. The memory may include a map DB or may be configured independently of the map DB, but is not limited thereto.

The user terminal 200 may refer to any form of entity(s) having a communication module 205 that is a mechanism for communicating with the server 100. The user terminal 200 may include, for example, a personal computer (PC), a laptop computer, a mobile terminal, a smartphone, a tablet PC, and a wearable device, and may include any type of terminals capable of connecting to a wired or wireless network. The user terminal 200 may also include any computing device implemented by at least one of an agent, an application programming interface (API), or a plug-in. The user terminal 200 may also include an application source and/or a client application.

In one embodiment, the user terminal 200 may include the communication module 205, an input module 210, and a display module 215. The user terminal 200 may include a processor and a memory, and the memory may store computer-readable instructions for implementing various functions of the user terminal 200. The processor may execute the computer-readable instructions to implement various modules including the communication module 205, the input module 210, and the display module 215.

The communication module 205 may be communicatively connected to the communication module 105 of the server 100 via a network (not shown). The network may refer to a connectivity structure that facilitates information exchange among a plurality of nodes such as user terminals and servers. The network may include, for example, a local area network (LAN), a wide area network (WAN), the Internet (e.g., world wide web (WWW)), a wired or wireless data communication network, a telephone network, a wired or wireless television communication network, a controller area network (CAN), an Ethernet, and the like. The wireless data communication network may include, for example, third-generation (3G), fourth-generation (4G), fifth-generation (5G), 3rd generation partnership project (3GPP), 5th generation partnership project (5GPP), long-term evolution (LTE), worldwide interoperability for microwave access (WIMAX), wireless fidelity (Wi-Fi), Internet, LAN, wireless LAN (WLAN), WAN, personal area network (PAN), radio frequency (RF), Bluetooth network, near-field communication (NFC) network, satellite broadcasting network, analog broadcasting network, digital multimedia broadcasting (DMB) network, and the like.

The input module 210 may be an interface for receiving an input from the user and may include, for example, a touchscreen, a touch pad, a keyboard, a mouse, a microphone, an image sensor, and the like.

The display module 215 may be a module for processing map information and search results received from the server 100 to display a map screen or search results on a UI of a map application executed on the user terminal 200.

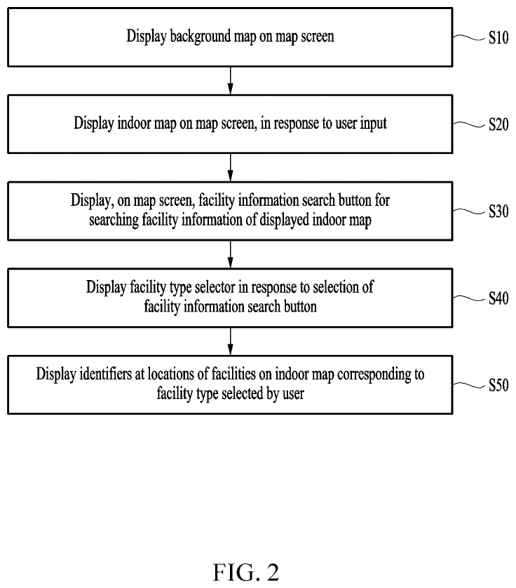

FIG. 2 is a flowchart schematically illustrating a method of providing an indoor map search service according to one embodiment of the present disclosure.

Referring to FIG. 2, according to one embodiment of the present disclosure, a method of providing an indoor map search service may first include step S10 of displaying a background map (e.g., a background map 230) on a map screen by the user terminal 200. In this case, a plurality of first POIs may be displayed on the background map 230 of the map screen. The user terminal 200 may receive the background map 230 and background map information including the plurality of first POIs from the server 100.

In step S20, in response to receiving a user input from the user, the user terminal 200 may display, on the map screen, an indoor map (e.g., an indoor map 280) of a specific first POI (e.g., a first POI 240). The indoor map 280 may include floor polygon information in which a structure of a specific floor of the first POI 240, for which an indoor map is to be displayed, is represented by polygons or lines. In this case, a plurality of second POIs may be displayed on the indoor map (i.e., the floor polygon information). Here, information about the indoor map 280 may be acquired as the user terminal 200 requests and receives the information about the indoor map 280 from the server 100 in response to receiving the user input. In this case, the user input (i.e., a user's manipulation on the map screen) may be an input or combination of inputs that zooms in a scale level of the map screen to a predetermined first level or higher such that the first POI for which the indoor map is available is present within a view point (or a field of view) of the map screen.

In one embodiment, the information about the indoor map 280 may include facility information (e.g., the facility information 125). The facility information 125 may include information (i.e., location (coordinate) information and detailed information) about public facilities such as restrooms, elevators, stairs, escalators, medical facilities, and convenient facilities (or amenities) such as information desks, stroller rentals, and the like, among other places (or points) on the indoor map.

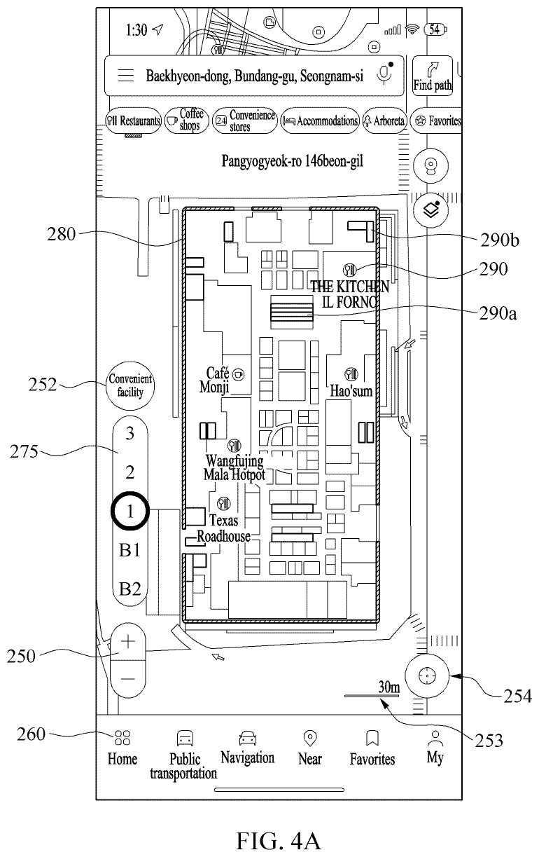

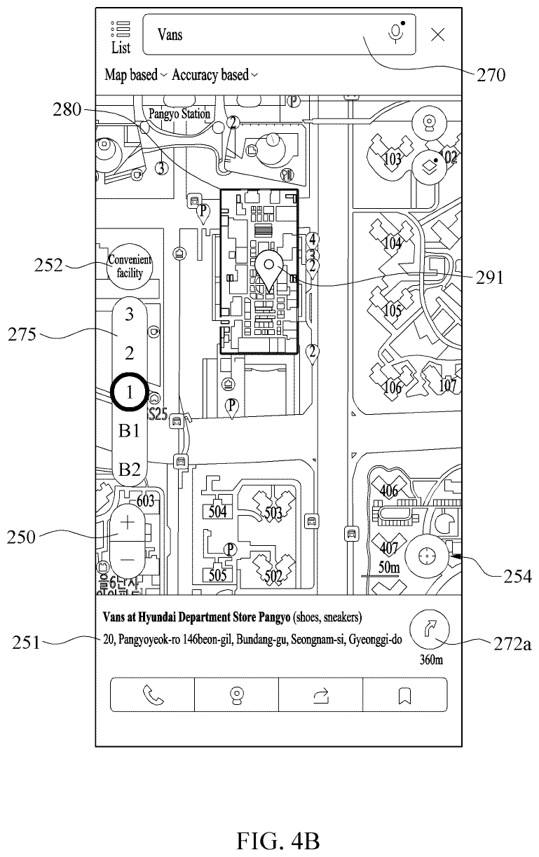

In step S30, a facility information search UI that facilitates an easy and simple search for facility information about facilities on the displayed indoor map may be displayed in an area of the map screen. As a non-limiting example, as shown in FIG. 4A, a facility information search UI 252 may be displayed on the left side of the indoor map, near a zoom in/out button 250 and a floor level display UI 275. As another example, the facility information search UI may be displayed below a search bar.

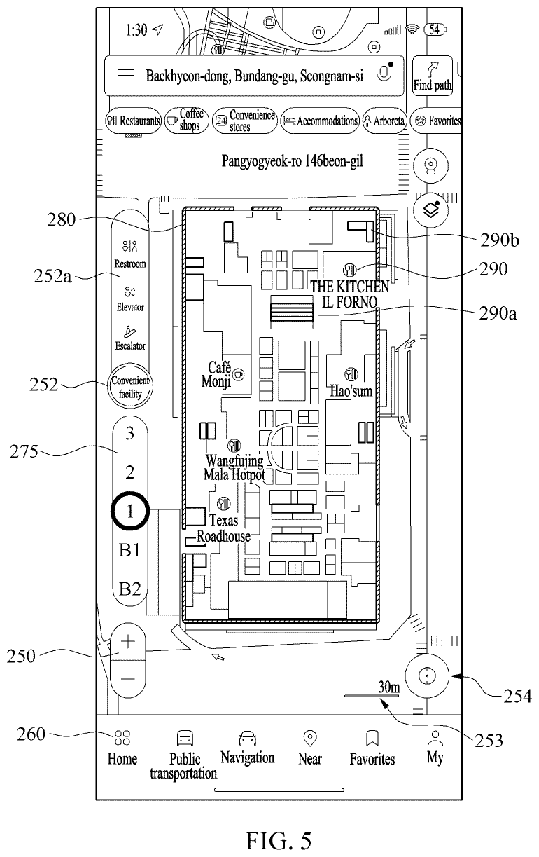

In step S40, in response to a user selection of the facility information search UI, a facility type selection UI that allows a selection of one or more facility types may be displayed. For example, as shown in FIG. 5, in response to a user selection of the facility information search UI 252, a facility type selection UI 252a may be displayed as an extension of the facility information search UI 252. For another example, in response to a user selection of the facility information search UI, the facility type selection UI may be displayed as a pop-up; some buttons previously displayed on the map screen may be changed to buttons included in the facility type selection UI; or the facility type selection UI may be displayed additionally in an area of the map screen.

In this case, the one or more facility types displayed on the facility type selection UI may be types corresponding to public facilities and convenient facilities (or amenities) including at least one of restrooms, elevators, escalators, stairs, medical facilities, information desks, or stroller rentals.

Also, the facility type selection UI may be removed in response to receiving an additional user selection of the facility information search UI while the facility type selection UI is being displayed.

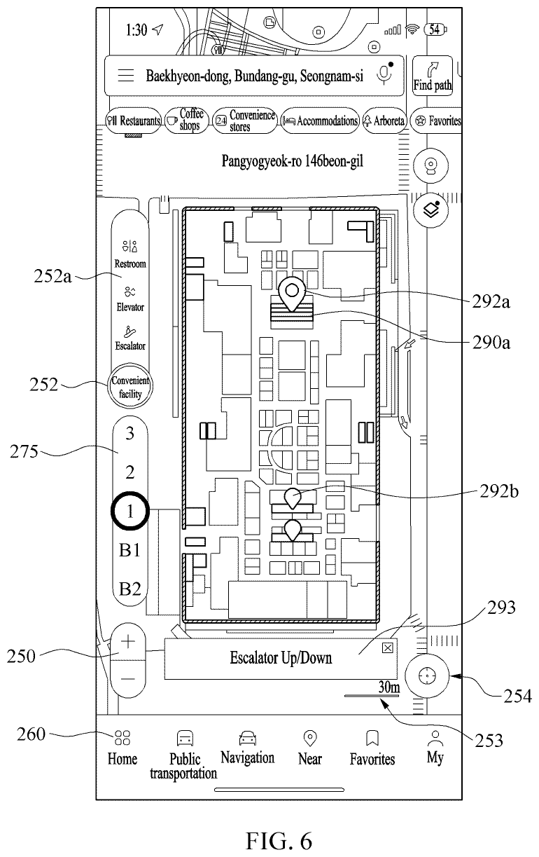

In step S50, in response to a user selection of one of the facility types displayed on the facility type selection UI, an identifier may be displayed at each of locations of one or more facilities on the indoor map corresponding to the selected facility type. For example, as shown in FIG. 6, in response to a user selection of one (e.g., escalator) of the facility types displayed on the facility type selection UI 252a, identifiers (e.g., 292a and 292b) may be displayed at respective locations of facilities corresponding to the selected facility type.

In one embodiment, in a case where there is a plurality of facilities on the indoor map corresponding to the selected facility type, an identifier set as a default or selected by the user among a plurality of identifiers respectively corresponding to the plurality of facilities may be displayed distinctively from remaining identifiers of the plurality of facilities. As a non-limiting example, in a case where the selected facility type is an escalator, an identifier (i.e., the identifier set as the default) for a main escalator located at the center of a building or an identifier for an escalator selected by the user may be displayed as having a distinct size relative to the remaining identifiers.

In one embodiment, detailed information (e.g., reference numeral 293 in FIG. 6) about a facility corresponding to the identifier set as the default or selected by the user may be displayed in an area of the map screen. The detailed information about the facility may be included in the facility information 125 included in the indoor map information received from the server 100.

According to embodiments of the present disclosure, the method of providing an indoor map search service may display a facility information search UI in an area of a map screen and enable a simple and easy search for facility information including convenient facilities or public facilities on an indoor map, by type, without an input of a separate search word, thereby enabling the user to perform a simple and intuitive search for the facility information within the indoor map and enhancing the user experience.

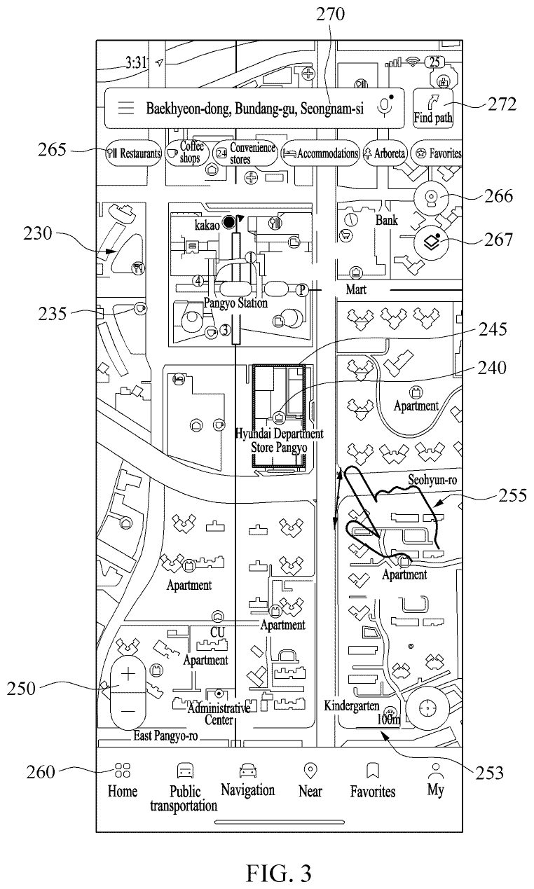

FIGS. 3 through 9 are diagrams illustrating examples of a map screen through which an indoor map search service is provided according to one embodiment of the present disclosure.

Hereinafter, an indoor map search service, according to embodiments of the present disclosure, will be described in detail using a map screen of a map application executed on a user terminal, with reference to FIGS. 3 through 9.

Referring to FIG. 3, when the user executes a map application via the user terminal 200, a map screen may be provided for a location set as a default, a current location of the user, or a location that the user has previously viewed via the map application. In this case, background map 230 may be displayed on the map screen, and a plurality of first POIs 235 may be displayed on the background map 230. The first POIs 235 may include, for example, stores, restaurants, salons, residential buildings, and public buildings such as subway stations.

As shown in FIG. 3, in a case where a scale level of the map screen is a predetermined level or higher and at least one first POI 240 for which an indoor map is available is present within a view point (or a field of view) of the map screen, area information 245 (e.g., provided in the form of a polygon, e.g., a rectangle) for the first POI 240 for which the indoor map is available may be displayed. The area information 245 may be included in indoor map information received from the server 100. In this case, displaying the area information 245 may enable the user to easily identify the first POI 240 for which the indoor map may be displayed.

Additionally, a zoom in/out button 250 for zooming in or out the map screen may be provided at a lower left end of the map screen. Without using the zoom in/out button 250, the user may also zoom in or out the map screen using a touch input 255 by, for example, pinching with two fingers or spreading the two fingers.

Additionally, a shortcut button tray 260 including a plurality of shortcut buttons for entering functions or settings screens such as home, public transportation, navigation, user information, and the like may be provided at the bottom of the map screen. Additionally, a scale bar 253 may be displayed at a lower right end of the map screen.

On the other hand, a search bar 270 for searching for a location or place (or point) may be provided at the top of the map screen, and a “find path” button 272 for entering a find path service that provides a function for providing directions to a desired place (or point) may be provided on the right side of the search bar 270. Below the search bar 270, there may be a category selection button 265 indicating categories related to locations or places (or points) such as restaurants, coffee shops, convenience stores, accommodations, arboreta, and the like. When a specific category button (e.g., a category button for restaurants) is selected, the map screen may display POIs corresponding to the category of restaurants. The map screen may also include a button 266 that provides a 3D street view of a selected point and a map settings button 267 that provides settings for a view on a map and the like.

Referring to FIG. 4A, an indoor map 280 (i.e., floor polygon information) of a specific floor of one first POI for which an indoor map is available within a view point may be displayed, when the map screen of FIG. 3 is zoomed in by the user via the zoom in/out button 250, the touch input 255, and the like, and the scale level of the map screen is the predetermined first level or higher. Additionally, one or more second POIs 290 may be displayed on the indoor map 280. The second POIs 290 displayed on the indoor map 280 may be located within the indoor map 280.

In one embodiment, facility information about public facilities 290a such as restrooms, elevators, stairs, escalators, medical facilities, and the like, and convenient facilities 290b such as information desks, stroller rentals, and the like may be set to be displayed permanently or preferentially compared to other second POIs.

In one embodiment, the facility information including information about the public facilities 290a and the convenient facilities 290b may be set to be transmitted and received as facility information for all floors of a target building or construction for which an indoor map is displayable, initially all at once, rather than being transmitted and received each time the indoor map on the map screen is updated or each time a floor selected by the user is changed by a floor level selector.

In one embodiment, when the indoor map 280 is displayed on the map screen, one area (e.g., a left side) of the map screen may display the zoom in/out button 250, the floor level display UI 275, and the facility information search UI 252 adjacent to each other. In the example of FIG. 4A, at a lower left end of the map screen, the zoom in/out button 250 may be displayed above the shortcut button tray 260, the floor level display UI 275 may be displayed above it, and the facility information search UI 252 may be displayed above it. However, examples are not limited thereto.

In one embodiment, when the indoor map 280 is displayed on the map screen, one area (e.g., the lower left end) of the map screen may display the floor level display UI 275 of the building or construction for which the indoor map 280 is being displayed. In this case, in the floor level display UI 275, a floor for which an indoor map (e.g., floor polygon information) is being displayed may be highlighted (e.g., circled), and the floor may also be located at the center of the floor level display UI 275. For example, in the example of FIG. 4A, an indoor map of a first floor may be displayed, and the first floor for which the indoor map is being displayed may be highlighted and located at the center of the floor level display UI 275 displayed at the lower left end of the map screen. The user may change the floor of the indoor map by scrolling through the floor level display UI 275 or by touching/clicking on a specific floor.

In one embodiment, the facility information search UI 252 may be displayed in one area of the map screen, for example, on the left side of the map screen, adjacent to the zoom in/out button and the floor level display UI. The facility information search UI 252 may be a button that facilitates searching for facility information about facilities on the indoor map displayed on the map screen. By the facility information search UI 252, the user may easily search for facility information about convenient facilities or public facilities within the indoor map without having to enter a search word.

Referring to FIG. 4B, entering the indoor map 280 (i.e., triggering the indoor map 280 to be displayed) may also be triggered by receiving a search request from the user (e.g., entering a search word) via the search bar 270, in addition to zooming in an area of the map screen in which an indoor map exists. In this case, even when the search request is for a POI located within a specific indoor map, it may also be triggered. For example, the example of FIG. 4B illustrates an example case where a store name “Vans” is input by the user into the search bar 270 as a search request and, upon receiving a user selection of Vans at Hyundai Department Store Pangyo from a search list provided as a search result for the search request, the indoor map 280 where a location of a corresponding POI (i.e., Vans at Hyundai Department Store Pangyo) is located is displayed. In this case, the indoor map 280 on which a second POI corresponding to the search request is located and an indicator 291 for the location of the POI on the indoor map 280 may be displayed, and the facility information search UI 252 may also be displayed in one area of the map screen to facilitate searching for facility information on the indoor map 280.

Further, as shown in FIG. 4B, a place panel 251 that provides a view of detailed information about the selected second POI may be provided on the map screen. The place panel 251 may be expandable by scrolling and the like, and may display more detailed information about the POI (or place) when expanded. The place panel 251 may also include a find path button 272a, which, when selected, may provide a path to the selected second POI using a find path service of the map application.

Referring to FIG. 5, in response to a user selection of the facility information search UI 252, a facility type selection UI 252a from which one or more facility types may be selected may be displayed as an extension of the facility information search UI 252. That is, when the facility information search UI 252 is displayed above a floor level selector 275, the facility type selection UI 252a may be displayed to extend upward from the facility information search UI 252.

In one embodiment, when the user selects the facility information search UI 252 one more time while the facility type selection UI 252a is being displayed as an extension of the facility information search UI 252, the facility type selection UI 252a may be removed. That is, the facility type selection UI 252a may be displayed and then removed repeatedly each time the user selects the facility information search UI 252.

In another embodiment, in response to a user selection of the facility information search UI 252, a facility type selection UI may be displayed in the form of a pop-up, and the pop-up may be removed upon a user selection of a specific facility type. Alternatively, some buttons previously displayed on the map screen may be replaced with buttons forming the facility type selection UI, or the facility type selection UI may be additionally displayed in an area (e.g., a blank space) of the map screen.

In one embodiment, one or more facility types displayed in the facility type selection UI 252a may include public facility and convenient facility types including at least one of restrooms, elevators, escalators, stairs, escalators, medical facilities, information desks, and stroller rentals. However, examples are not limited thereto, and various facility types in addition to the preceding may also be displayed depending on the settings. For example, the facility type selection UI 252a may display various facility types such as a popular facility that exists only at a specific location (e.g., a promotional location for a particular brand whose presence has not been officially established yet in South Korea) such that the user easily searches therefor.

In one embodiment, the facility type selection UI 252a may be displayed as scrollable in response to, for example, a touch input that scrolls the facility type selection UI 252a from top to bottom or bottom to top being received from the user. Therefore, it is possible to display multiple facility types in a limited area. That is, although, in the example of FIG. 5, escalators, elevators, and restrooms are displayed in the facility type selection UI 252a, other facilities may also be displayed as being selectable by such a scrolling input from the user.

Referring to FIG. 6, in response to a user selection of any one of facility types displayed in the facility type selection UI 252a, identifiers 292a and 292b may be displayed at respective locations of one or more facilities within the indoor map 280 corresponding to the selected facility type 252a′. In the example of FIG. 6, in response to a user selection of an escalator (e.g., 252a′) from among the facility types displayed in the facility type selection UI 252a, a facility type corresponding to the escalator 252a′ may be highlighted, and the identifiers 292a and 292b may be displayed at respective locations corresponding to the escalator 252a′.

In one embodiment, in a case where there is a plurality of facilities within the indoor map 280 corresponding to the selected facility type 252a′, the identifier 292a set as a default or selected by the user among a plurality of identifiers may be displayed in the form distinctive from the remaining identifier 292b. In the example of FIG. 6, in a case where the selected facility type 252a′ is an escalator, an identifier of a main escalator located at the center of the building (i.e., an identifier set as the default) or an identifier 292a of an escalator selected by the user may be displayed such that it has a different size from that of the remaining identifier 292b. However, the form in which an identifier is to be displayed may not be limited to the preceding example, and there may be various modifications to the form.

In one embodiment, detailed information 293 of a facility corresponding to the identifier 292a set as the default or selected by the user may be displayed in one area of the map screen. The detailed information 293 of the facility may include a specific description of the facility, such as, for example, escalator going up/down (e.g., “elevator up/down”).

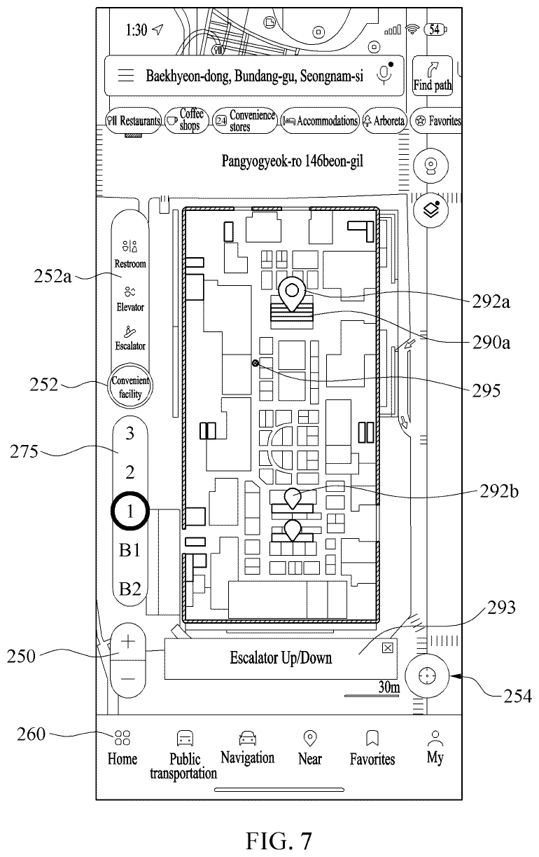

Referring to FIG. 7, when one of facilities of the selected facility type 252a′ is selected based on a current location 295 of the user, an identifier 292a of the facility may be displayed distinctively from a remaining identifier 292b and, at the same time, detailed information 293 of the facility may be displayed. For example, when a user selection of a current location button 254 located at a lower right end of the map screen is received as shown in FIG. 7, the current location 295 of the user may be displayed on the map screen, and an identifier 292a of a facility closest to the user may be highlighted and displayed.

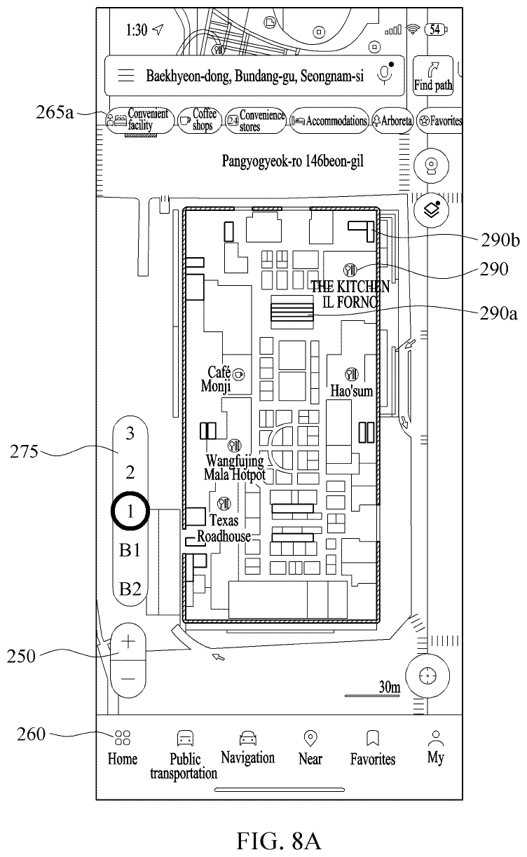

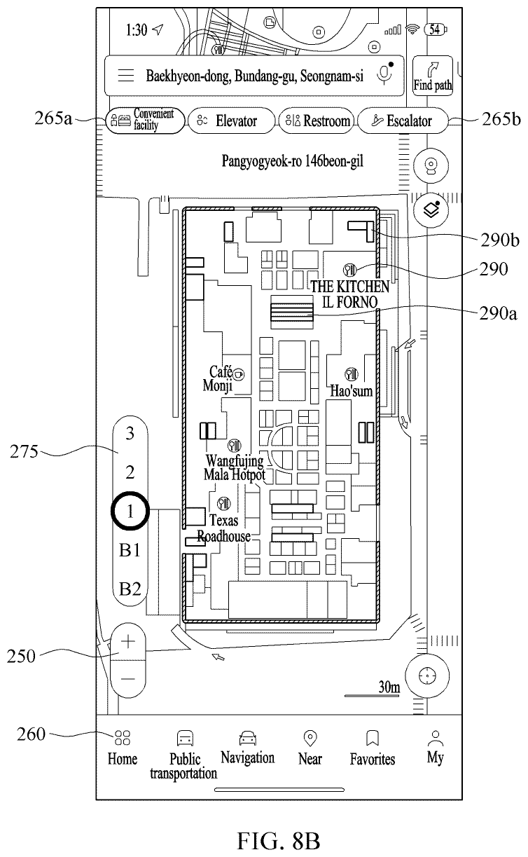

FIGS. 8A and 8B are diagrams illustrating a method of displaying a facility information search UI according to another embodiment of the present disclosure.

Referring first to FIG. 8A, according to one embodiment, category selection buttons 265 representing categories associated with places (or points) such as restaurants, coffee shops, convenience stores, accommodations, arboreta, and the like may be displayed below a search bar 270. In one embodiment, any one of the category selection buttons 265 may be configured as a facility information selection button 265a. That is, compared to the facility information selection button 252 described above with reference to FIG. 4A, the facility information selection button 265a of FIG. 8A may be configured as one of the category selection buttons 265. The facility information selection button 265a may be displayed only when an indoor map is provided on a map screen currently being viewed by the user, but is not limited thereto.

Referring to FIG. 8B, when the facility information selection button 265a is selected from the category selection buttons 265 as shown in FIG. 8A, the category selection buttons 265 may be changed to one or more facility type buttons 265b indicating facility types. That is, the one or more facility type buttons 265b may be buttons indicating the facility types such as elevators, restrooms, escalators, and the like. Alternatively, the one or more facility type buttons 265b that form a facility type selection UI may be displayed in one area of the map screen.

In this way, using the category selection buttons 265 below the search bar 270 may enable an easy and simple selection of facility information without the use of an additional spatial area of the map screen, enhancing the user experience.

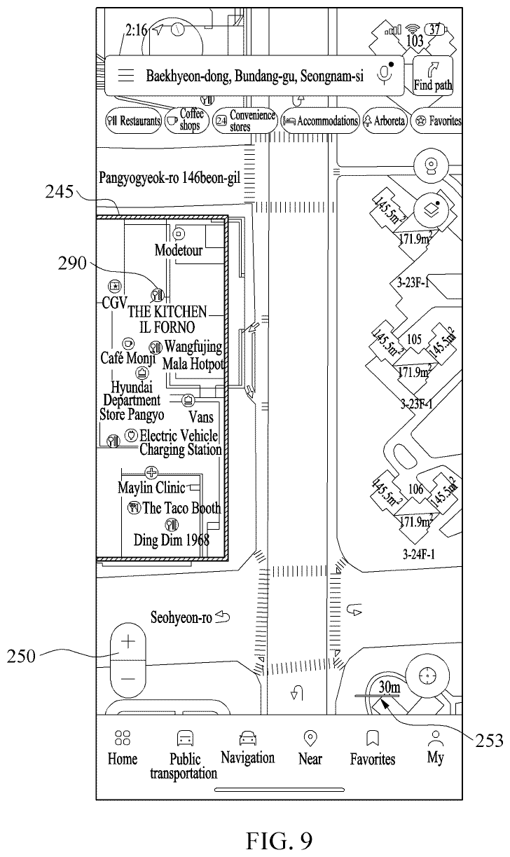

Referring to FIG. 9, when an indoor map departs from the center of a map screen as the user moves the map screen of FIG. 8A or FIG. 8B or the map screen is zoomed out via a zoom in/out button 250 or a touch input 255, and a scale level of the map screen is a first level or lower, displaying the indoor map may be terminated. In one embodiment, when the indoor map is out of the center of the map screen as shown in FIG. 9, only area information 245 of the indoor map may be displayed instead of the indoor map, even when the scale level of the map screen becomes the first level or higher. In addition, a plurality of second POIs 290 in the indoor map may be displayed by merging all POIs in a building, rather than a POI for each floor, and rendering them. In another embodiment, when the indoor map is out of the center of the map screen, only background map information, i.e., a background map and a plurality of first POIs, may be displayed, and indoor map information may not be displayed.

In one embodiment, when a state where the indoor map is displayed and a state where the indoor map is not displayed are repeated by the user manipulating the map screen, a floor of the indoor map that has been displayed last may be set to be displayed again the next time the indoor map is to be displayed.

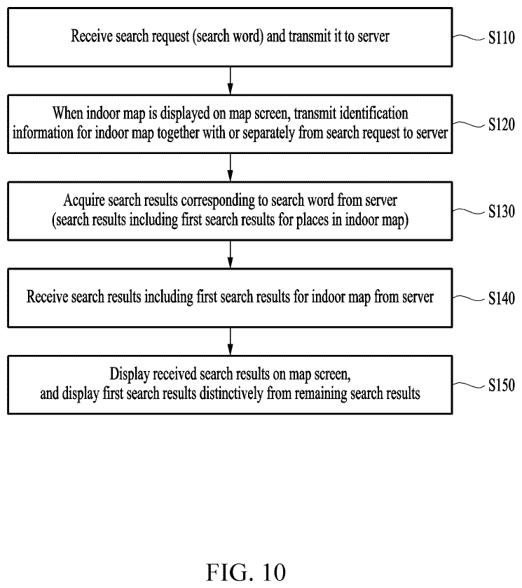

FIG. 10 is a flowchart schematically illustrating a method of searching for facility information about facilities on an indoor map according to one embodiment of the present disclosure.

Referring to FIG. 10, according to one embodiment of the present disclosure, a method of searching for a place (or point) within an indoor map may include step S110 in which the server 100 may receive a search request transmitted from the user terminal 200. The user terminal 200 may transmit the search request to the server 100. The search request may include a search word input by the user terminal 200 via a search bar on a map screen.

In one embodiment, in step S120, when an indoor map is displayed on the map screen, the user terminal 200 may transmit identification information for the indoor map together with or separately from the search request. The server 100 may then receive the identification information for the indoor map.

In step S130, the server 100 may acquire search results corresponding to the search word. In one embodiment, the search results corresponding to the search word may include first search results for places (or points) in the indoor map, and the first search results may be distinguished from the rest of the search results as they are assigned different identifiers or the like. The places (or points) in the indoor map may include POIs including facilities such as restrooms, elevators, escalators, and the like, and shops, restaurants, and the like. The search results may be acquired by the search engine 115 (or the map service provision module 110) by searching the map DB 120 of the server 100.

In step S140, the server 100 may transmit the search results including the first search results for the indoor map to the user terminal 200, and the user terminal 200 may receive the search results.

In step S150, the user terminal 200 may display the search results on a screen. In this case, the first search results for the places (or points) in the indoor map may be displayed preferentially over the remaining search results or may be displayed distinctively from the remaining search results.

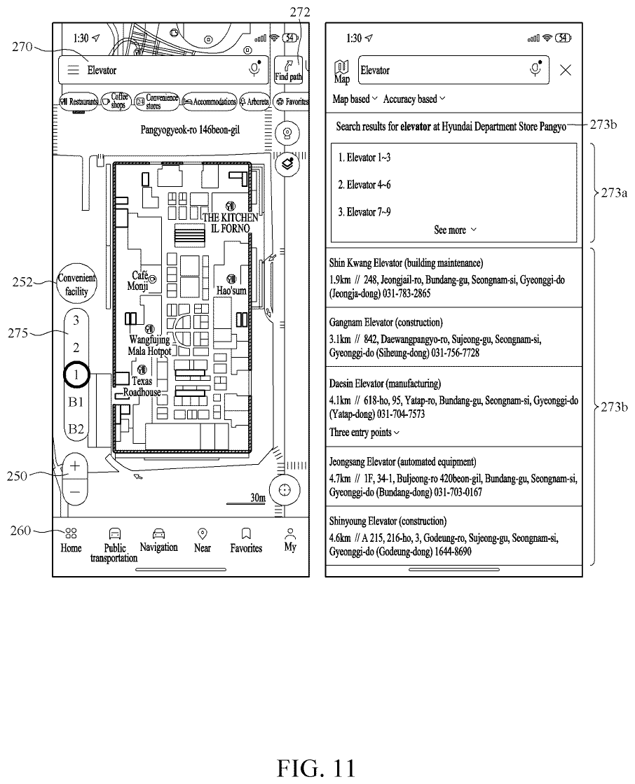

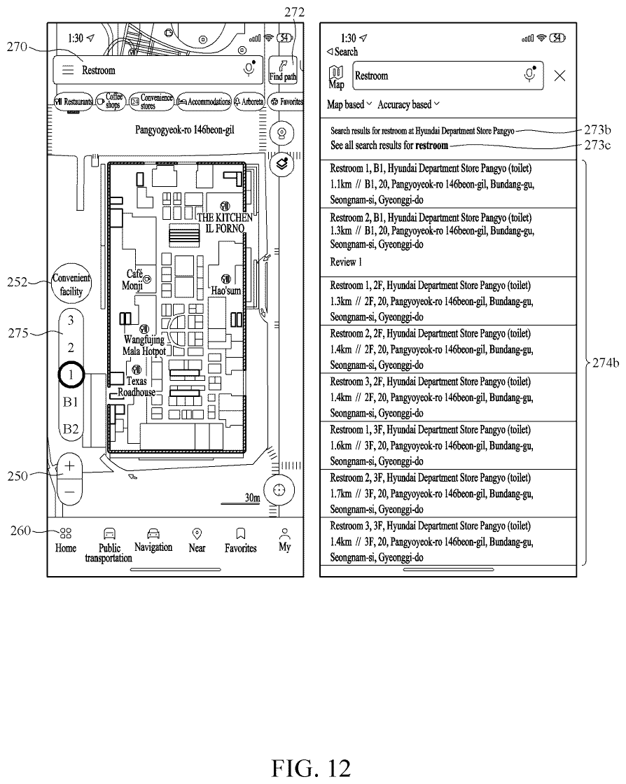

FIGS. 11 and 12 are diagrams illustrating examples of displaying search results in a map application according to one embodiment of the present disclosure.

Referring to FIG. 11, of all search results, a first search result 273a for an indoor map may be displayed in a predetermined number (e.g., three) at the top, along with a descriptive phrase 273b indicating that it is a place (or point) within the indoor map. When a button “see more” is selected from the user, the first search result 273a may be expanded to display more than the predetermined number of results. In addition, of all the search results, remaining search results 273b other than the first search result 273a for the indoor map may be listed and displayed below the first search result 273a.

In the example of FIG. 11, as a search result for a search word “elevator” (or search request), the first search result 273a for elevators in Hyundai Department Store Pangyo, which is currently being displayed, may be displayed at the top and the remaining search results 273b may be displayed below the first search result 273a.

Referring to FIG. 12, of all search results, a first search result 274b for an indoor map may be displayed fully on a screen with a descriptive phrase 273b indicating that it is a place (or point) within the indoor map. When a “sell all search results” button 273c is selected by the user, all the search results may be displayed fully on the screen instead of the first search result 274b.

In the example of FIG. 12, as a search result for a search word “restroom” (or search request), the first search result 274b for restrooms in Hyundai Department Store Pangyo, which is currently being displayed, may be displayed fully on the screen. Then, upon receiving a user selection of a “see all search results for restroom” button, which is the “sell all search results” button 273c, all the search results may be displayed fully on the screen instead of the first search result 274b.

As such, according to embodiments, displaying a first search result for an indoor map distinctively from remaining search results, or displaying preferentially the first search result, may enable the user to easily identify locations on the indoor map, enhancing the user experience.

Further, according to other embodiments, the server 100 may determine whether a search word is for a facility (e.g., a public facility, a convenient facility, etc.), and display a first search result and remaining search results for an indoor map distinctively from each other only when the search word is for the facility. When the user inputs the search word for the facility while viewing the indoor map, the user is highly likely to have searched for the facility on the indoor map, and in such case, the user experience may be enhanced.

The embodiments of the present disclosure may provide a computer-readable storage medium on which a computer program or instructions are stored, and when the computer program or instructions are executed by at least one processor, the steps and operations of the methods described herein may be implemented.

The computer-executable instructions stored on the recording medium may be implemented by a computer program programmed to perform each step or operation, and the computer program may be stored on the computer-readable recording medium and executable by the processor. The computer-readable recording medium may be a non-transitory readable medium. In this case, the non-transitory computer-readable recording medium refers to a medium that stores data semi-permanently and is readable by a device, rather than a medium that stores data for a short period of time, such as, for example, a register, cache, memory, and the like. Specifically, the programs for performing the various methods or operations described above may be stored and provided on non-transitory readable media such as erasable programmable read-only memory (EPROM), electrically erasable programmable read-only memory (EEPROM), semiconductor memory devices such as flash memory devices, magnetic disks such as internal hard disks and removable disks, optical-magnetic discs, and non-volatile memory including compact disc read-only memory (CD-ROM) and digital versatile disc read-only memory (DVD-ROM) discs.

According to various embodiments, the methods described herein may be included and provided in a computer program product. The computer program product may be traded as a product between a seller and a buyer. The computer program product may be distributed in the form of a machine-readable storage medium (e.g., CD-ROM), or be distributed (e.g., downloaded or uploaded) online via an application store (e.g., PlayStore™) or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

As described above, one of ordinary skill in the art to which the present disclosure pertains will understand that the present disclosure may be practiced in other specific forms without alterations of the technical ideas or essential features. Therefore, the embodiments described above should not be understood as exemplary or limited in all respects. The scope of the present disclosure is more clearly covered by the following claims, rather than by the detailed description, and should be construed as including the meaning and scope of the claims and all modifications or alterations derived from equivalent concepts.

The features and advantages described herein are not exhaustive, and many additional features and advantages will become apparent to one of ordinary skill in the art, particularly in light of the drawings, specification, and claims. Furthermore, it should be noted that the language used herein may be chosen primarily for ease of reading and for purposes of instruction and may not be chosen to describe or limit the subject matter of the disclosure.

The preceding description of embodiments of the present disclosure is presented for illustrative purposes. It is not intended to limit the disclosure to the exact form disclosed or to render it without omission. It is apparent to one of ordinary skill in the art that modifications and alterations are possible in light of the disclosure.

The scope of the present disclosure is therefore not limited by the detailed description, but rather by the claims of any application based thereon. Accordingly, the description of embodiments of the present disclosure is exemplary and is not intended to limit the scope of the disclosure as set forth in the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing an indoor map search service, the method comprising:
displaying, on a map screen, a background map and an indoor map of a point of interest (POI) on the background map; and
displaying, in an area of the map screen, a facility information search user interface (UI) that facilitates a search for facility information about facilities included in the indoor map.

2. The method of claim 1, further comprising:
in response to receiving a user selection of the facility information search UI, displaying a facility type selection UI from which one or more facility types are selectable.

3. The method of claim 2, wherein the displaying of the facility type selection UI comprises at least one of:
displaying the facility type selection UI as an extension of the facility information search UI;
displaying the facility information search UI in replacement of a UI previously displayed on the map screen; or
displaying the facility information search UI in an area of the map screen.

4. The method of claim 3, wherein, in response to receiving an additional user selection of the facility information search UI while the facility type selection UI is being displayed, the facility type selection UI is removed.

5. The method of claim 2, wherein the facility type selection UI is displayed as scrollable.

6. The method of claim 2, wherein the one or more facility types displayed on the facility type selection UI comprises at least one of a restroom, an elevator, an escalator, stairs, a medical facility, an information desk, or a stroller rental place.

7. The method of claim 2, further comprising:
in response to a user selection of one of the facility types displayed on the facility type selection UI, displaying an identifier at each of locations of one or more facilities within the indoor map corresponding to the selected facility type.

8. The method of claim 7, wherein, when there is a plurality of facilities within the indoor map corresponding to the selected facility type, any one of a plurality of identifiers respectively corresponding to the plurality of facilities is displayed distinctively from remaining identifiers.

9. The method of claim 8, wherein the one of the identifiers displayed distinctively from the remaining identifiers corresponds to a facility closest to a current location of a user.

10. The method of claim 7, further comprising:
displaying, in an area of the map screen, detailed information about a facility corresponding to the one of the identifiers.

11. The method of claim 1, wherein the map screen comprises a floor level display UI for displaying floor information of the indoor map, and
wherein the facility information search UI is displayed near the floor level display UI.

12. The method of claim 1, wherein the map screen comprises a search bar, and a plurality of category selection buttons adjacent to the search bar, and
wherein the plurality of category selection buttons comprises the facility information search UI

13. The method of claim 12, wherein, in response to a selection of the facility information search UI, a portion of the plurality of category selection buttons is changed to a facility type button and the facility type button is displayed.

14. A device for providing an indoor map search service, the device configured to:
display, on a map screen, a background map and an indoor map of a point of interest (POI) on the background map; and
display, in an area of the map screen, a facility information search user interface (UI) that facilitates a search for facility information about facilities included in the indoor map.

15. A non-transitory computer-readable recording medium comprising computer-executable instructions,
wherein the computer-executable instructions are configured to perform, when executed by one or more processors, a method of providing an indoor map search service,
wherein the method comprises:
displaying, on a map screen, a background map and an indoor map of a point of interest (POI) on the background map; and
displaying, in an area of the map screen, a facility information search user interface (UI) that facilitates a search for facility information about facilities included in the indoor map.

16. A method of searching for a point on an indoor map, the method comprising:
transmitting a search request;
in response to an indoor map being displayed on a map screen displayed on a user terminal, transmitting identification information about the indoor map; and
receiving search results corresponding to the search request, the search results comprising first search results for one or more points on the indoor map.

17. The method of claim 16, further comprising:
displaying the search results on a screen of the user terminal,
wherein the first search results are displayed distinctively from remaining search results.

18. The method of claim 17, wherein the displaying of the first search results distinctively from the remaining search results comprises:
displaying a selected number of results among the first search results above the remaining search results.

19. The method of claim 17, wherein the displaying of the first search results distinctively from the remaining search results comprises:
displaying the first search results fully on the screen of the user terminal.
